(19) United States
(12) Patent Application Publication
(10) Pub. No.: US 2016/0169133 A1
(43) Pub. Date: Jun. 16, 2016

(54) SYSTEM AND METHOD FOR INCREASING GASEOUS FUEL SUBSTITUTION

(71) Applicant: CATERPILLAR INC., Peoria, IL (US)

(72) Inventors: Mary Louise YEAGER, Lafayette, IL (US); Francis Leonard CLARK, Pekin, IL (US); Brandon Glenn GREGORY, Peoria, IL (US)

(73) Assignee: CATERPILLAR INC., Peoria, IL (US)

(21) Appl. No.: 14/567,418

(22) Filed: Dec. 11, 2014

(51) Int. Cl. F02D 41/00; F02D 41/24; F02D 41/14

(52) U.S. Cl. CPC F02D 41/0027; F02D 41/0085; F02D 41/1443; F02D 41/2438

(57) ABSTRACT

A fuel control system for a multiple fuel internal combustion engine may include at least one cylinder pressure sensor associated with each cylinder of the engine. A data collection module may be configured to receive real-time cylinder pressure measurements from each of the at least one cylinder pressure sensors and calculate one or more actual combustion parameter values from the real-time cylinder pressure measurements. A comparison module may be configured to receive the calculated one or more actual combustion parameter values from the data collection module and compare the calculated one or more actual combustion parameter values for each cylinder to reference combustion parameter values to determine any difference therebetween, wherein the reference combustion parameter values are the same for each of the cylinders. A process control module may be configured to control fuel injection of at least two different types of fuel supplied to each cylinder in order to reduce any difference between the calculated actual combustion parameter values for each cylinder and the reference combustion parameter values.

### TECHNICAL FIELD

The present disclosure relates generally to gaseous fuel substitution in multiple fuel internal combustion engines, and more particularly, to a system and method for increasing gaseous fuel substitution.

### BACKGROUND

Gaseous fuel powered engines and engines that operate on multiple different fuels are used in a variety of applications. For example, the engine of a locomotive or other heavy equipment can be powered by natural gas. A preferred form of natural gas for transport on mobile vehicles is liquefied natural gas (LNG) because of its higher energy density. The LNG can be transported in a gaseous fuel tank, pressurized, and heated into a gaseous state before it is delivered to an internal combustion engine. The compressed natural gas (CNG) may be injected into the cylinders of the engine and ignited, such as by a spark or pilot fuel (e.g., diesel fuel). In one example, CNG is injected using high pressure direct injection (HPDI), where a high pressure pump pressurizes LNG before it is warmed to a supercritical gaseous state and then sent to an HPDI internal combustion engine.

As an example of a dual fuel internal combustion engine, U.S. Pat. No. 6,073,592 to Brown et al. (“the '592 patent”) discloses a control system comprising a master electronic control module controlling the diesel fuel mode functions, and one or more slave electronic control modules controlling the gaseous fuel functions of the dual fuel engine. The master electronic control module communicating with the one or more slave electronic control modules drives the diesel fuel injectors, processes sensor data required for diesel operation, monitors and protects the engine during diesel operation, starts and stops the engine, and processes operator input. The remaining electronic control functions are allocated among the slave electronic control modules, which include controlling the solenoid gas admission valves. The master electronic control module transitions operation to the liquid fuel mode in the event of a failure of any gaseous fuel mode specific components, or if communication between the master electronic control module and the slave electronic control modules fails. Therefore, operation of the engine may be continued even if one or all of the slave electronic control modules fail.

Although the dual fuel engine disclosed in the '592 patent includes controls that allow the transition from dual fuel mode to diesel fuel only mode in the event of a failure of any dual fuel mode specific components, there is room for improvement. The relative costs and availability of the different types of fuel used by the engine may also create a situation where it would be desirable to increase the amount of the least expensive fuel and/or most readily available fuel that can be used by the engine. The different combustion characteristics of different types of fuel, and even for the same type of fuel obtained from different sources, creates a need for control systems that are able to maximize the amount of a preferred fuel that can be used while still meeting all operational goals, and automatically adjust for different fuels having different combustion characteristics.

The disclosed system is directed to overcoming one or more of the problems set forth above and/or other problems with existing technologies.

### SUMMARY OF THE DISCLOSURE

According to an aspect of the present disclosure, a control system for a multiple fuel internal combustion engine may include at least one cylinder pressure sensor associated with each cylinder of the engine. The control system may further include a data collection module configured to receive real-time cylinder pressure measurements from each of the at least one cylinder pressure sensors and calculate one or more actual combustion parameter values from the real-time cylinder pressure measurements. The control system may still further include a comparison module configured to receive the calculated one or more actual combustion parameter values from the data collection module and compare the calculated one or more actual combustion parameter values for each cylinder to reference combustion parameter values to determine any difference therebetween, wherein the reference combustion parameter values are the same for each of the cylinders. The control system may also include a process control module configured to control fuel injection of at least two different types of fuel supplied to each cylinder in order to reduce any difference between the calculated actual combustion parameter values for each cylinder and the reference combustion parameter values.

According to another aspect of the present disclosure, a multiple fuel internal combustion engine operable in a combination liquid and gaseous fuel mode may include a plurality of cylinders, a real-time cylinder pressure sensor associated with each of the plurality of cylinders, a liquid fuel injection system, a gaseous fuel injection system, and a control system. The control system may include a data collection module configured to receive real-time cylinder pressure measurements from each of the cylinder pressure sensors and calculate one or more actual combustion parameter values from the real-time cylinder pressure measurements. The control system may further include a comparison module configured to receive the calculated one or more actual combustion parameter values from the data collection module and compare the calculated one or more actual combustion parameter values for each cylinder to reference combustion parameter values to determine any difference therebetween, wherein the reference combustion parameter values are the same for each of the cylinders. The control system may also include a process control module configured to control one or more of fuel injection of at least a liquid fuel and a gaseous fuel, and ignition in order to reduce any difference between the calculated actual combustion parameter values for each cylinder and the reference combustion parameter values.

According to another aspect of the present disclosure, a method for controlling a multiple fuel internal combustion engine operable in at least a combination liquid and gaseous fuel mode may include receiving real-time cylinder pressure measurements from each of the cylinders of the multiple fuel internal combustion engine. The method may further include calculating one or more actual combustion parameter values based on the real-time cylinder pressure measurements. The method may still further include comparing the calculated actual combustion parameter values for each cylinder to reference combustion parameter values to determine any difference therebetween, wherein the reference combustion parameter values are the same for each of the cylinders. The method may also include controlling one or more of fuel injection of at least a liquid fuel and a gaseous fuel, and ignition in order to reduce any difference between the calculated actual combustion parameter values for each cylinder and the reference combustion parameter values.

Other features and aspects of this disclosure will be apparent from the following description and the accompanying drawings.

### BRIEF DESCRIPTION OF THE DRAWINGS

FIG. 1 shows an exemplary schematic diagram of a multiple fuel internal combustion engine;

FIG. 2 shows a schematic diagram of a control system for a multiple fuel internal combustion engine;

FIG. 3 shows an exemplary block diagram illustrating a closed loop control of each cylinder of the multiple fuel internal combustion engine of FIG. 1; and

FIG. 4 shows a flow diagram illustrating steps of the closed loop control of FIG. 3.

### DETAILED DESCRIPTION

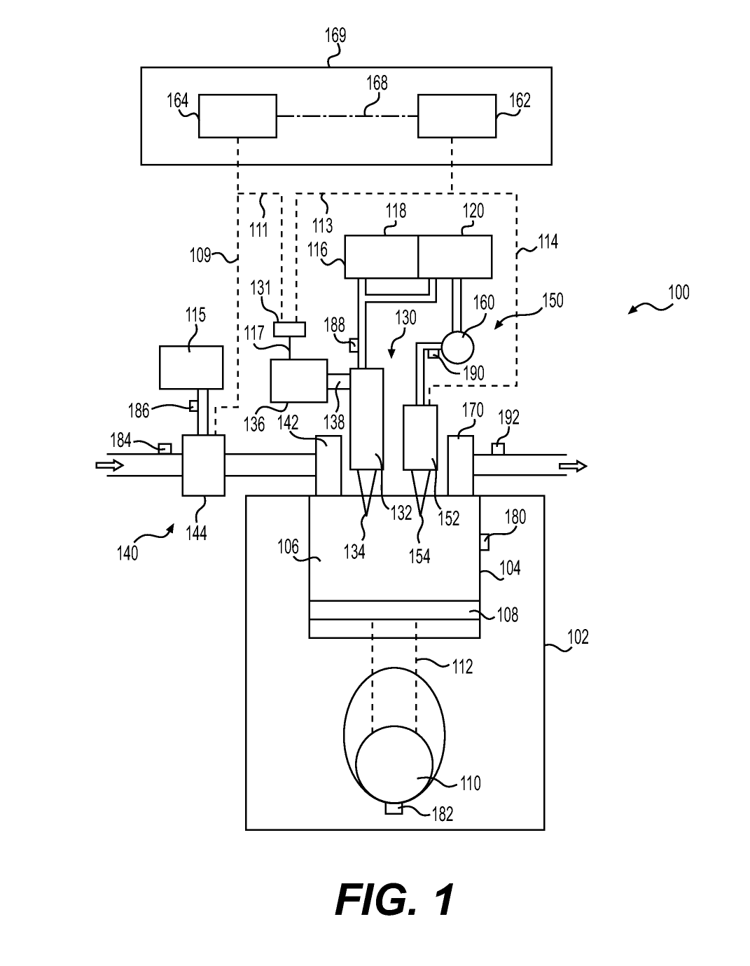

FIG. 1 illustrates an exemplary implementation of a multiple fuel internal combustion engine 100 that may be operated with different types of fuels, such as heavy fuel oil (HFO), diesel fuel, biodiesel, gasoline, and natural gas. The exemplary multiple fuel engine 100 may be operated in a liquid fuel mode, a gaseous fuel mode, and a combination liquid and gaseous fuel mode.

During a liquid fuel mode, a liquid fuel injection system 130 provides liquid fuel to the charge air within a combustion chamber 106, and the charge air/liquid fuel mixture may be ignited by compression. Diesel engines and homogeneous charge compression ignition (HCCI) engines rely on auto-ignition for the initiation of combustion, in contrast to spark ignition engines such as gasoline powered engines. In a spark ignition engine auto-ignition is undesirable because it causes knock, and too much knock can create stresses on the engine that exceed an acceptable threshold level. The tendency of a fuel to auto-ignite is inversely proportional to the octane level of the fuel. In high performance, high compression spark ignition engines, a higher octane fuel may be required to avoid undesirable knock. Fuels for diesel engines and HCCI engines that rely on auto-ignition for initiation of combustion are typically given a cetane rating that is the direct opposite of the octane rating since the cetane rating is a measure of a fuel's tendency toward auto-ignition. Gaseous fuels such as CNG are more difficult to auto-ignite than diesel fuel, typically requiring a compression ratio for auto-ignition that may be more than ten times as high as a compression ratio that results in auto-ignition of a diesel fuel. Therefore, different methods of blending gaseous fuels with liquid fuels for ignition purposes have been developed. During a gaseous fuel mode, a gaseous fuel such as natural gas may be controllably released into an air intake port connected to a cylinder 104, producing a charge air/gaseous fuel mixture. In a combination liquid and gaseous fuel mode, after a predetermined period of time, a small amount of diesel fuel may be injected into the cylinder 104 containing a charge air/gaseous fuel mixture in order to ignite the fuel mixture. The amount of the diesel fuel used as an ignition fuel may be about 3% of the fuel amount injected during a liquid fuel mode. Compression ignites the diesel fuel, which in turn ignites the charge air/gaseous fuel mixture. To operate in a liquid fuel mode as well as a gaseous fuel mode, a control system for a multiple fuel internal combustion engine may control components of the liquid fuel injection system 130, a gaseous fuel injection system 140, and an ignition fuel injection system 150.

Referring to FIG. 1, an exemplary schematic diagram of a multiple fuel internal combustion engine 100 including an engine unit, an air system, a fuel system, and a control system is shown. The engine unit may include an engine block 102, at least one cylinder 104 providing at least one combustion chamber 106 for combusting fuel, a piston 108, and a crank-shaft 110 connected to the piston 108 via a piston rod 112. The piston 108 may be configured to reciprocate within the cylinder 104.

In various implementations according to this disclosure, the multiple fuel internal combustion engine 100 may be used as a power source on an off-highway mining truck, a large marine vessel for propulsion, in a petroleum application such as well fracking or drilling, and other applications that may benefit from the flexibility offered by such engines. In some of these implementations the multiple fuel internal combustion engine may use multiple fuels in a dynamic gas blending (DGB) mode. A DGB mode may be characterized by gaseous fuel being injected and mixed with air in the cylinders 104, and a subsequent injection of liquid fuel may ignite the air/gaseous fuel mixture.

The air system may include an inlet valve 142 fluidly connected to the at least one combustion chamber 106, and an outlet valve 170 also fluidly connected to the at least on combustion chamber 106. The inlet valve 142 may be configured to enable injection of compressed charge air and/or a mixture of compressed charge air and gaseous fuel into the at least one combustion chamber 106. After combusting the liquid fuel and/or gaseous fuel, the exhaust may be released out of the at least one combustion chamber 106 via the outlet valve 170 into an associated exhaust gas system (not shown) for treating the exhaust gas.

The fuel system may include a gaseous fuel tank 115 for storing the gaseous fuel, for example natural gas, and a liquid fuel tank unit 116, which may include a first liquid fuel tank 118 for storing, for example, HFO, or biodiesel oil, and a second liquid fuel tank 120 for storing, for example, diesel fuel. The fuel system may further include the liquid fuel injection system 130, the gaseous fuel injection system 140, and the ignition fuel injection system 150. The liquid fuel injection system 130 may be configured to inject liquid fuel originating from the liquid fuel tank unit 116 into the at least one combustion chamber 106. A liquid fuel injector 132 may be supplied with HFO, biodiesel oil, or other liquid fuel from the first liquid fuel tank 118 or with diesel fuel from the second liquid fuel tank 120.

The liquid fuel injector 132 may include a liquid fuel injector nozzle 134 fluidly communicating with the at least one combustion chamber 106. An actuator 136 may be configured to control the amount of liquid fuel injected by the liquid fuel injector 132. The actuator 136 may be a mechanical actuator connected to the liquid fuel injector 132 via a fuel rack 138 for controlling the amount of injected liquid fuel, or more typically, an electrical solenoid actuator or piezoelectric actuator driven by a control signal received from an engine control unit.

The gaseous fuel injection system 140 may be configured to inject gaseous fuel originating from the gaseous fuel tank 115 into the at least one combustion chamber 106. The gaseous fuel injection system 140 may include a gas admission valve 144, for example a solenoid-actuated or electrohydraulic-actuated gas admission valve, which may be arranged upstream of the inlet valve 142 and may be configured to mix gaseous fuel originating from the gaseous fuel tank 115 with compressed charge air. The mixture of gaseous fuel and compressed charge air may be injected into the at least one combustion chamber 106 via the inlet valve 142.

The ignition fuel injection system 150 may be configured to inject a small amount of liquid fuel, preferably diesel fuel or other high cetane fuel, into the at least one combustion chamber 106. The ignition fuel injection system 150 may include an ignition fuel injector 152 having an ignition fuel injector nozzle 154 that is in fluid communication with the at least one combustion chamber 106 and a common rail system 160 receiving diesel fuel from the second liquid fuel tank 120 of the liquid fuel tank unit 116. The ignition fuel injector 152 may be supplied with diesel fuel from the common rail system 160. In various alternative implementations, fuel injectors may be provided that inject both gaseous fuel and diesel fuel according to a selected one of a plurality of combustion modes.

In one exemplary implementation, a control system may be configured to select between a high pressure direct injection (HPDI) mode and at least one gas blending mode. In the HPDI mode, high pressure gaseous fuel may be injected after a liquid fuel injection, igniting at some point during compression of the fuels. In the gas blending mode(s), gaseous fuel may be injected and mixed with air in the cylinder, and a subsequent injection of liquid fuel may ignite the air/gaseous fuel mixture. In some implementations, the control system may be configured to select between at least two dynamic gas blending modes, including a direct injection-dynamic gas blending (DI-DGB) and a dynamic gas blending (DGB) mode.

The control system may comprise a control unit 169 including a first electronic control module 162, a second electronic control module 164, and several control lines connected to the respective components of the fuel system. The first electronic control module 162 may be connected to the second electronic control module 164 via a bus 168. One of ordinary skill in the art will recognize that in various alternative implementations one or more electronic control modules may be provided at one or more locations. The functions performed by the first and second electronic control modules of the exemplary implementation shown in FIG. 1 may alternatively be performed by a single electronic control module.

The first electronic control module 162 may be configured to control the liquid fuel mode of the multiple fuel internal combustion engine 100. Specifically, the first electronic control module 162 may be connected to the actuator 136 via a connection line 113 and a hardware connection, such as a relay 131. The hardware connection may also be embodied by multiple relays 131. The hardware connection may alternatively or in addition be embodied by a diode or by multiple diodes. Diodes may allow a continuous connection rather than a switched connection between the first electronic control module 162 and the actuator 136.

During the liquid fuel mode, the first electronic control module 162 may provide a liquid fuel amount control signal to the actuator 136 via the connection line 113. The liquid fuel amount control signal may indicate a desired liquid fuel amount to be injected into the at least one combustion chamber 106. In addition, the first electronic control module 162 may be configured to generally control the multiple fuel internal combustion engine 100 such as by controlling the engine speed and delivered fuel/power from the engine. Moreover, during the gaseous fuel mode, the first electronic control module 162 may be configured to control the ignition fuel injection system 150 via a connection line 114.

The second electronic control module 164 may be configured to control the gaseous fuel mode of the multiple fuel internal combustion engine 100. Specifically, the second electronic control module 164 may be connected to the gas admission valve 144 via a connection line 109. Furthermore, the second electronic control module 164 may be connected to the actuator 136 via a connection line 111 and the relay 131. During the gaseous fuel mode, the second electronic control module 164 may provide a gaseous fuel amount control signal to the gaseous admission valve 144 via the connection line 109. The gaseous fuel amount control signal may indicate a desired gaseous fuel amount to be mixed with compressed charge air within the gaseous admission valve 144, which mixture may be injected into the at least one combustion chamber 106. At the same time, the first electronic control module 162 may provide an ignition fuel amount control signal to the ignition fuel injector 152 via the connection line 114. The ignition fuel amount control signal may indicate a desired ignition fuel amount to be injected into the at least one combustion chamber 106 for igniting the gaseous mixture. For example, the small amount of injected ignition liquid fuel may be about 3% of the amount of injected liquid fuel during the liquid fuel mode. One of ordinary skill in the art will recognize that alternative implementations may include controlling the gas admission valve 144 by hydraulic and/or electrohydraulic means. The liquid fuel may also serve as the hydraulic fluid used to control actuation of the gas admission valve. The first and second electronic control modules 162, 164 may also control the timing of injections of liquid and gaseous fuels in a manner that controls when auto-ignition will occur.

The control system may further include several sensors for measuring actual operational parameter values of the multiple fuel internal combustion engine 100. For example, the control system may include a cylinder pressure sensor 180 for sensing the real-time pressure within the at least one combustion chamber 106, a crank shaft speed sensor 182 for measuring the speed of the crank shaft 110, a charge air pressure sensor 184 for measuring the pressure of the compressed charge air, a gaseous fuel pressure sensor 186 for measuring the pressure of the gaseous fuel, a liquid fuel pressure sensor 188 for measuring the pressure of the liquid fuel, a common rail pressure sensor 190 for measuring the pressure of the liquid fuel within the common rail 160, and an exhaust gas pressure sensor 192 for measuring the pressure of the exhaust gas released out of the at least one combustion chamber 106. The control system may also include other sensors, such as rotational speed sensors, timing sensors, transmission gear position sensors, gas constituent sensors, and other sensors measuring various vehicle, engine, and combustion parameters.

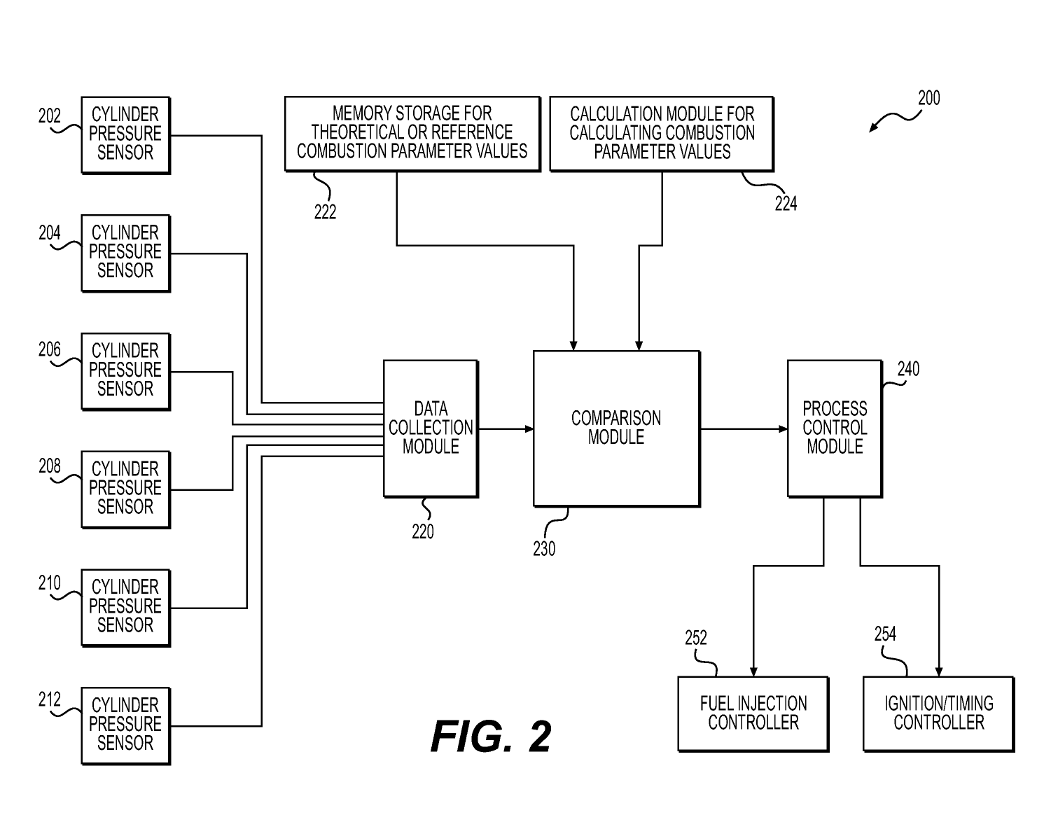

FIG. 2 illustrates an exemplary implementation of a control system 200 according to this disclosure, wherein only cylinder pressure sensors are shown as the sensors providing input to the control system. One of ordinary skill in the art will recognize that a large variety of sensors measuring various engine operating and combustion parameters such as those discussed above may all provide input to the control system. In the exemplary implementation of FIG. 2, cylinder pressure sensors 202, 204, 206, 208, 210, 212 may each be associated with a different cylinder of a multiple fuel internal combustion engine. Multiple cylinder pressure sensors may also be provided for each cylinder at different locations on each cylinder if desired. A data collection module 220 may be configured to receive real-time cylinder pressure measurements from each of the at least one cylinder pressure sensors. The data collection module 220 of the control system 200 may also be configured to calculate one or more actual combustion parameter values from the real-time cylinder pressure measurements received from the cylinder pressure sensors.

A comparison module 230 of control system 200 may be configured to receive the calculated one or more actual combustion parameter values from the data collection module 220 and compare the calculated one or more actual combustion parameter values for each cylinder to reference combustion parameter values to determine any difference therebetween. The reference combustion parameter values may be the same for each of the cylinders.

A process control module 240 may be configured to control at least one of fuel injection of at least two different types of fuel supplied to each cylinder, and ignition timing in order to reduce any difference between the calculated actual combustion parameter values for each cylinder and the reference combustion parameter values. Although shown as a separate module in FIG. 2, the various functions of process control module 240 may alternatively be performed in the comparison module 230. A fuel injection controller 252 may be configured to control both liquid fuel injection and gaseous fuel injection, such as performed by the first electronic control module 162 and the second electronic control module 164 in the exemplary implementation of FIG. 1. An ignition/timing controller 254 may be configured to implement the desired timing of ignition and/or fuel injection. Because there may be a delay between when an ignition fuel such as diesel fuel is first injected into the cylinder and when auto-ignition from compression actually begins, the timing of ignition may be controlled by the timing of injection of the ignition fuel. The comparison module 230 may be configured to receive the reference combustion parameter values from one or more of a memory storage 222 and a calculation module 224. The reference combustion parameter values in memory storage 222 may be relatively fixed values stored in the form of maps or other predetermined data structures. Alternatively or in addition, calculation module 224 may provide reference combustion parameter values that are the result of real-time or periodically updated calculations or algorithms designed to determine the best value or values for achieving a predefined goal. One of ordinary skill in the art will recognize that the various modules shown in the exemplary implementation of FIG. 2 may be combined into one or more processors, and embodied in one or more of software, hardware, firmware, or any combination thereof.

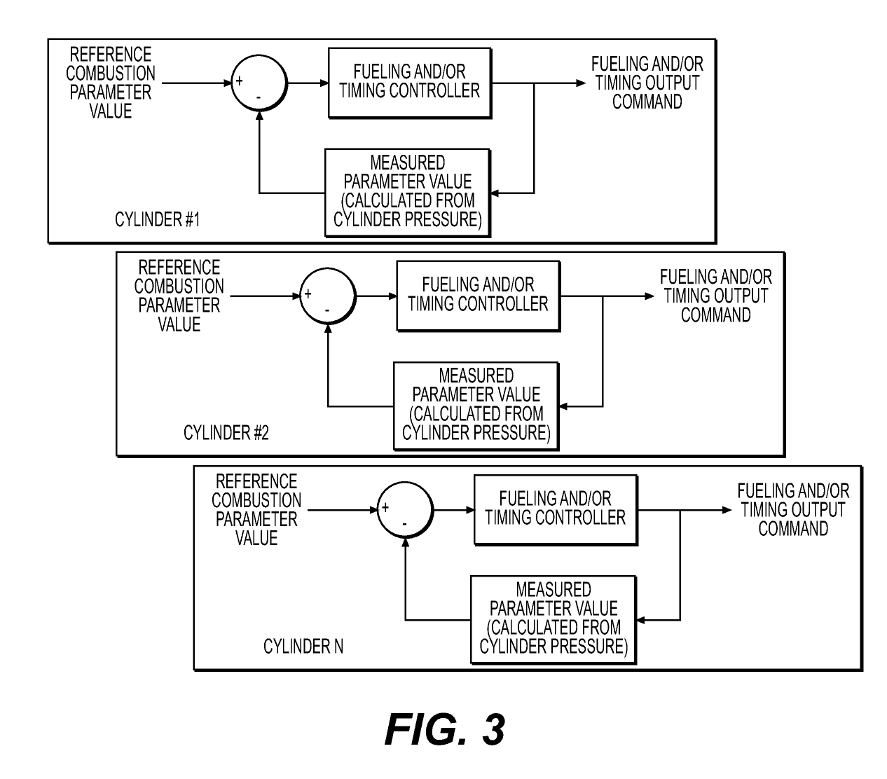

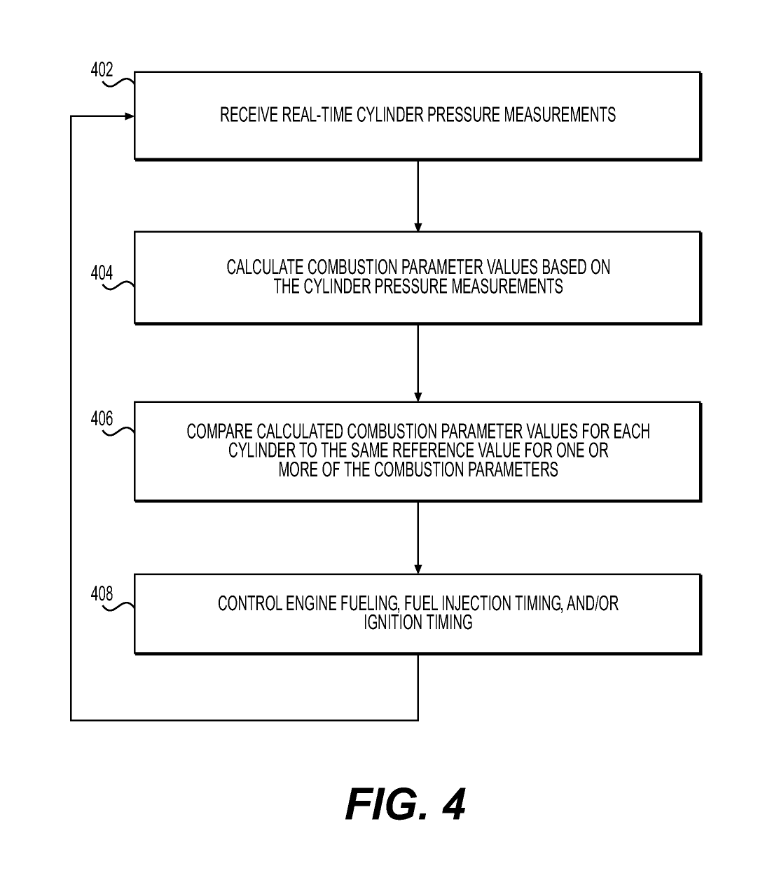

An exemplary implementation of a closed loop process that may be performed by the above-described control system is shown in FIGS. 3 and 4, which will be described in detail in the following section.

### INDUSTRIAL APPLICABILITY

The disclosed control system is applicable to any multiple fuel internal combustion engine, and provides a method for implementing a desired operational characteristic such as a higher ratio of gaseous fuel to liquid fuel used by the engine. As natural gas prices have dropped relative to other fuels, and the availability has increased domestically with new technologies such as fracking, there is a demand for increasing the ratio of natural gas relative to other fuels used in various industrial and consumer applications. One way to achieve this increase is to provide systems and methods that allow for increased gaseous fuel substitution in multiple fuel internal combustion engines.

The use of greater amounts of gaseous fuel such as CNG in a multiple fuel internal combustion engine may impose higher stresses on the engine as a result of higher compression ratios and the potential for increased engine knock. Variations in physical and operational characteristics from one cylinder to another may also result in limitations on the maximum amount of gaseous fuel that can be used by the engine. Different cylinders may produce different amounts of power, different levels of emissions, different amounts of knock, or other variables. As one example, a cylinder producing more knock than all of the other cylinders may be the limiting factor for how much gaseous fuel the engine may burn. Accurate, real-time measurement of actual combustion parameter values for each of the cylinders may allow for adjustments to controls for each cylinder to balance all of the cylinders and avoid having any one cylinder becoming a limiting factor. Balancing of the power output or other combustion characteristics between all of the cylinders may enable optimization of an overall engine operational characteristic such as gaseous fuel substitution. Once controls for each individual cylinder have been adjusted to balance all of the cylinders, optimization of any particular operational characteristic for the entire engine may be more readily achieved as a result of having removed limitations imposed by any one cylinder.

Balancing of all of the cylinders may be enabled in a closed loop process by comparing the calculated one or more actual combustion parameter values for each cylinder to the same reference combustion parameter values to determine any difference therebetween. When a difference is greater than a threshold level, the process may include adjusting one or more of fueling, injection, and ignition timing at each cylinder in order to reduce any difference between the calculated actual combustion parameter values for each of the cylinders and the reference combustion parameter values. The process may be repeated until any difference is less than the threshold level.

The closed loop process for balancing all of the cylinders may include an algorithm for determining the desired reference combustion parameter values to which each of the calculated actual combustion parameter values will be compared. In various non-limiting implementations, reference combustion parameter values may be calculated from the actual combustion parameter values for each of the cylinders as one or more of the median, the mean, the lowest, or the highest of the actual values from each of the cylinders. The selected method for calculating the reference combustion parameter values may be based upon a variety of factors including the combustion parameter itself, any limitations of the engine hardware, and the amount of deviation among actual combustion parameter values for the cylinders. The selected method may also change in real-time in order to respond appropriately to engine ambient environmental conditions, engine operating requirements, active diagnostics on, e.g., various fuel system components, and other variables.

Each of the cylinders may also be balanced relative to the other cylinders in more than one way. For example, one balancing algorithm may change the fueling quantity to balance each of the cylinders' peak pressures or indicated mean effective pressure (IMEP) values. Another balancing algorithm may change fueling or ignition timing to balance the cylinders' start of combustion or center of combustion values. Steps may be taken when balancing the cylinders using more than one balancing algorithm such that the algorithms do not work against each other and create an instability condition. One example of such a precaution may be to run one algorithm at a fast loop time, and run a second algorithm at a slower loop time.

The calculated one or more actual combustion parameter values and the reference combustion parameter values may be selected in order to allow for optimization of a desired characteristic, such as the ratio of gaseous fuel to liquid fuel used by the engine. Combustion parameter values may include peak cylinder pressure, IMEP, maximum heat released, maximum rate of pressure rise, estimated combustion gas temperature, location of peak cylinder pressure, location of maximum rate of pressure rise, crank angle of start of combustion, crank angle of center of combustion, and crank angle of opening or closing of an inlet or outlet valve for each of the cylinders. Various combustion parameters, such as the crank angle of opening or closing of an inlet or outlet valve may be varied using engine control electronics. Balancing all of the cylinders based on one or more of these combustion parameter values may enable the engine to use a maximum ratio of gaseous fuel to liquid fuel. The maximum ratio of gaseous fuel to liquid fuel may be determined in a closed loop process such as shown in FIGS. 3 and 4. As shown in FIG. 3, each of the N number of cylinders may be controlled simultaneously or in succession in accordance with the illustrated closed loop process. For each cylinder, a reference combustion parameter value may be compared to a measured parameter value that has been calculated from an actual, real-time cylinder pressure measured by a cylinder pressure sensor for that cylinder. The results of that comparison are then used to send signals to fueling and/or timing controllers. The fueling and/or timing controllers produce output commands, and new cylinder pressure readings are used to update the measured parameter values, which are again compared to the reference combustion parameter values. The timing controllers may alter timing of injection of fuels, timing of a spark in the case of a spark-ignited engine, and the timing of opening or closing of an inlet or outlet valve for each of the cylinders. The reference combustion parameter values to which all of the cylinders are balanced may be selected from a calibration curve, map, or other data source. The reference combustion parameter values may have been determined from theoretical calculations or from empirical data. The calculations or data may be associated with a hypothetical or actual multiple fuel internal combustion engine using a ratio of gaseous fuel to liquid fuel that one or more of provides a reduction in total fuel costs and a reduction in emissions, while still meeting power output requirements for the engine and maintaining stress on the engine below an acceptable threshold level.

Reference combustion parameter values that are obtained from calculation module 224 may require more processing power than simply retrieving values from a fixed memory storage 222, but may also offer more flexibility and value to a customer. Optimization functions may be performed by the calculation module 224 in order to determine the best reference combustion parameter value or combination of values to achieve a pre-defined goal. In some implementations, an optimization algorithm performed by the calculation module 224 may assign each of a variety of fuels suitable for use by the engine a cost. The assigned cost may be the actual cost of the fuel, e.g., $2. per gallon, or a cost based on a variety of characteristics associated with the fuel. In one possible variation, the optimization algorithm may attempt to maximize the quantity of the least costly fuel used by the engine until a first condition, X, occurs. One possible example of a first condition, X, may be a predefined amount of knock experienced by the engine. Upon reaching the condition X, the algorithm may then switch to the next least costly fuel until some other condition, Y, occurs, etc. Alternatively or in addition, a small amount of a specific fuel may be necessary all the time, such as the small quantity of diesel fuel that may be necessary to start the combustion process. Conditions X and Y may be evaluated by looking at combustion parameters calculated from the cylinder pressure sensor measurements and/or other engine sensors.

Some examples of conditions that may be addressed by the optimization algorithm as indicative of a need to adjust the quantities of a particular fuel, or change to a different fuel entirely, may include: 1) running out of a more preferred fuel; 2) responding to an active diagnostic code on an injection component of a more preferred fuel system; 3) reaching physical limitations on an injection component of a more preferred fuel system (for example the gas admission valve can't stay open long enough to put an adequate amount of gaseous fuel into the cylinder); 4) experiencing transient throttle demand that exceeds a desired threshold for a more preferred fuel system; 5) experiencing altitude, temperature, humidity, or other environmental conditions that dictate changes to the quantity or type of fuel; 6) experiencing engine emissions output levels that dictate a typically less preferred fuel to maintain compliance with governing standards; and 7) receiving user inputs via service tools, remote interfaces, engine-mounted panels, and graphical user interfaces (GUI) on or off the machine, may dictate the use of less preferred fuels. The optimization algorithm may assume that the engine cylinders have already been balanced on an individual basis, such as by using combustion parameters calculated from the cylinder pressure sensors. As discussed above, balancing of the individual cylinders relative to a common reference combustion parameter value may avoid a situation where one or two poorly performing cylinders will limit the efficiency of the entire engine. The balancing adjustments may be unique for each cylinder, while the optimization algorithm described above may be applied equally to all cylinders of the engine. Alternatively, if processing loop time and hardware memory allow, the optimization algorithm could be implemented uniquely for each cylinder, thereby essentially combine the balancing and optimization steps.

As shown in FIG. 3, the balancing process may be performed simultaneously or in succession for each individual cylinder 104 of the multiple fuel internal combustion engine 100. Actual combustion parameter values are calculated for each cylinder 104 from real-time cylinder pressure measurements taken by cylinder pressure sensors 180 in each cylinder 104. These one or more actual combustion parameter values are then compared to the same reference combustion parameter values for all of the cylinders 104. Fueling and/or timing controllers may then produce fueling and/or timing output commands to control one or more of fuel injection of at least a liquid fuel and a gaseous fuel into each cylinder, and ignition of the fuel in each cylinder in order to reduce any difference between the calculated actual combustion parameter values for each cylinder and the reference combustion parameter values. This process may be continued in a closed loop until the difference between the calculated actual combustion parameter values for each cylinder and the reference combustion parameter values is less than a threshold level.

As shown in FIG. 4, the balancing process for any one cylinder 104 may begin at step 402 with a controller receiving real-time cylinder pressure measurements from one or more cylinder pressure sensors 180 located in the cylinder 104. At step 404 a data collection module 220 may then calculate actual combustion parameter values based on the cylinder pressure measurements.

At step 406 a comparison module 230 may compare the calculated actual combustion parameter values for the cylinder 104 to the same reference combustion parameter value used for all of the other cylinders. The comparison module 230 may have received the reference combustion parameter values from the memory storage 222 or the calculation module 224. The calculation module 224 may be configured to calculate the reference combustion parameter values from at least one of theoretical, empirical, and historical data associated with a multiple fuel internal combustion engine using a ratio of gaseous fuel to liquid fuel that one or more of provides a reduction in total fuel costs and a reduction in emissions, while still meeting power output requirements for the engine and maintaining stress on the engine below an acceptable threshold level. As explained above, optimization functions may be performed by the calculation module 224 in order to determine the best reference combustion parameter value or combination of values to achieve a pre-defined goal.

When the difference between the calculated actual combustion parameter values for the cylinder and the reference combustion parameter value is above a desired threshold level, a process control module 240 may control one or more of engine fueling, fuel injection timing, and ignition timing for each of the cylinders 104 at step 408 in order to balance all of the cylinders. The process may be continued in a closed loop by returning to step 402 after controlling operational parameters for each cylinder 104 at step 408 and again receiving real-time cylinder pressure measurements for each cylinder 104 at step 402.

It will be apparent to those skilled in the art that various modifications and variations can be made to the disclosed control system. Other embodiments will be apparent to those skilled in the art from consideration of the specification and practice of the disclosed concepts. It is intended that the specification and examples be considered as exemplary only, with a true scope being indicated by the following claims and their equivalents.

1. A control system for a multiple fuel internal combustion engine having one or more cylinders, comprising:
at least one cylinder pressure sensor associated with each cylinder of the engine;
a data collection module configured to receive real-time cylinder pressure measurements from each of the at least one cylinder pressure sensors and calculate one or more actual combustion parameter values from the real-time cylinder pressure measurements;
a comparison module configured to receive the calculated one or more actual combustion parameter values from the data collection module and compare the calculated one or more actual combustion parameter values for each cylinder to reference combustion parameter values to determine any difference therebetween, wherein the reference combustion parameter values are the same for each of the cylinders; and
a process control module configured to control fuel injection of at least two different types of fuel supplied to each cylinder in order to reduce any difference between the calculated actual combustion parameter values for each cylinder and the reference combustion parameter values.

2. The control system of claim 1, wherein the comparison module is further configured to receive the reference combustion parameter values from a memory storage.

3. The control system of claim 2, wherein the reference combustion parameter values from the memory storage are combustion parameter values associated with a multiple fuel internal combustion engine using a higher percentage of a gaseous fuel than a percentage of gaseous fuel currently being used by the multiple fuel internal combustion engine.

4. The control system of claim 3, wherein the reference combustion parameter values from the memory storage are combustion parameter values associated with the multiple fuel internal combustion engine using a ratio of gaseous fuel to liquid fuel that one or more of provides a reduction in total fuel costs and a reduction in emissions, while still meeting power output requirements for the engine and maintaining stress on the engine below an acceptable threshold level.

5. The control system of claim 1, wherein the calculated one or more actual combustion parameter values and the reference combustion parameter values include one or more of peak cylinder pressure, indicated mean effective pressure (IMEP), maximum heat released, maximum rate of pressure rise, estimated combustion gas temperature, location of peak cylinder pressure, location of maximum rate of pressure rise, crank angle of start of combustion, crank angle of center of combustion, and crank angle of opening or closing of an inlet or outlet valve for each of the cylinders of the multiple fuel internal combustion engine.

6. The control system of claim 5, wherein the reference combustion parameter values are combustion parameter values associated with the multiple fuel internal combustion engine using a ratio of gaseous fuel to liquid fuel that one or more of provides a reduction in total fuel costs and a reduction in emissions, while still meeting power output requirements for the engine and maintaining stress on the engine below an acceptable threshold level.

7. The control system of claim 1, wherein the process control module is further configured to control the timing of one or more of fuel injection of at least two different types of fuel and ignition of the at least two different types of fuel.

8. The control system of claim 1, further including the data collection module being configured to recalculate one or more actual combustion parameter values from new real-time cylinder pressure measurements taken after the process control module controls fuel injection of at least two different types of fuel in order to reduce any difference between the calculated actual combustion parameter values for each cylinder and the reference combustion parameter values, the recalculation by the data collection module continuing in a closed loop process until the difference between the calculated actual combustion parameter values and the reference combustion parameter values is less than a predetermined threshold.

9. The control system of claim 1, wherein the comparison module is further configured to receive the reference combustion parameter values from a calculation module configured to calculate the reference combustion parameter values from at least one of theoretical, empirical, and historical data associated with a multiple fuel internal combustion engine using a ratio of gaseous fuel to liquid fuel that one or more of provides a reduction in total fuel costs and a reduction in emissions, while still meeting power output requirements for the engine and maintaining stress on the engine below an acceptable threshold level.

10. A multiple fuel internal combustion engine operable in a combined liquid and gaseous fuel mode; comprising:
a plurality of cylinders;
a real-time cylinder pressure sensor associated with each of the plurality of cylinders;
a liquid fuel injection system;
a gaseous fuel injection system; and
a control system comprising:
a data collection module configured to receive real-time cylinder pressure measurements from each of the cylinder pressure sensors and calculate one or more actual combustion parameter values from the real-time cylinder pressure measurements;
a comparison module configured to receive the calculated one or more actual combustion parameter values from the data collection module and compare the calculated one or more actual combustion parameter values for each cylinder to reference combustion parameter values to determine any difference therebetween, wherein the reference combustion parameter values are the same for each of the cylinders; and
a process control module configured to control one or more of fuel injection of at least a liquid fuel and a gaseous fuel, and ignition in order to reduce any difference between the calculated actual combustion parameter values for each cylinder and the reference combustion parameter values.

11. The multiple fuel internal combustion engine of claim 10, wherein the comparison module is further configured to receive the reference combustion parameter values from a memory storage.

12. The multiple fuel internal combustion engine of claim 11, wherein the reference combustion parameter values from the memory storage are combustion parameter values associated with the multiple fuel internal combustion engine using a higher percentage of a gaseous fuel than a percentage of gaseous fuel currently being used by the multiple fuel internal combustion engine.

13. The multiple fuel internal combustion engine of claim 12, wherein the reference combustion parameter values from the memory storage are combustion parameter values associated with the multiple fuel engine using a ratio of gaseous fuel to liquid fuel that one or more of provides a reduction in total fuel costs and a reduction in emissions, while still meeting power output requirements for the engine and maintaining stress on the engine below an acceptable threshold level.

14. The multiple fuel internal combustion engine of claim 10, wherein the calculated one or more actual combustion parameter values and the reference combustion parameter values include one or more of peak cylinder pressure, indicated mean effective pressure (IMEP), maximum heat released, maximum rate of pressure rise, estimated combustion gas temperature, location of peak cylinder pressure, location of maximum rate of pressure rise, crank angle of start of combustion, crank angle of center of combustion, and crank angle of opening or closing of an inlet or outlet valve for each of the cylinders of the engine.

15. The multiple fuel internal combustion engine of claim 14, wherein the reference combustion parameter values are combustion parameter values associated with the multiple fuel internal combustion engine using a ratio of gaseous fuel to liquid fuel that one or more of provides a reduction in total fuel costs and a reduction in emissions, while still meeting power output requirements for the engine and maintaining stress on the engine below an acceptable threshold level.

16. The multiple fuel internal combustion engine of claim 10, wherein the process control module is further configured to control the timing of one or more of fuel injection of at least two different types of fuel and ignition of the at least two different types of fuel.

17. The multiple fuel internal combustion engine of claim 10, further including the data collection module being configured to recalculate one or more actual combustion parameter values from new real-time cylinder pressure measurements taken after the process control module controls one or more of fuel injection and ignition in order to reduce any difference between the calculated actual combustion parameter values for each cylinder and the reference combustion parameter values, the recalculation by the data collection module continuing in a closed loop process until the difference between the calculated actual combustion parameter values and the reference combustion parameter values is less than a predetermined threshold.

18. The multiple fuel internal combustion engine of claim 10, wherein the comparison module is further configured to receive the reference combustion parameter values from a calculation module configured to calculate the reference combustion parameter values from at least one of theoretical, empirical, and historical data associated with a multiple fuel internal combustion engine using a ratio of gaseous fuel to liquid fuel that one or more of provides a reduction in total fuel costs and a reduction in emissions, while still meeting power output requirements for the engine and maintaining stress on the engine below an acceptable threshold level.

19. A method for controlling a multiple fuel internal combustion engine operable in at least a combination liquid and gaseous fuel mode, the method comprising:
receiving real-time cylinder pressure measurements from each of the cylinders of the multiple fuel internal combustion engine;
calculating one or more actual combustion parameter values based on the real-time cylinder pressure measurements;
comparing the calculated actual combustion parameter values for each cylinder to reference combustion parameter values to determine any difference therebetween, wherein the reference combustion parameter values are the same for each of the cylinders; and
controlling one or more of fuel injection of at least a liquid fuel and a gaseous fuel, and ignition in order to reduce any difference between the calculated actual combustion parameter values for each cylinder and the reference combustion parameter values.

20. The method of claim 19, wherein the reference combustion parameter values are combustion parameter values associated with the internal combustion engine using a ratio of gaseous fuel to liquid fuel that one or more of provides a reduction in total fuel costs and a reduction in emissions, while still meeting power output requirements for the engine and maintaining stress on the engine below an acceptable threshold level.
